(19) United States
(12) Patent Application Publication
(10) Pub. No.: US 2006/0033641 A1
(43) Pub. Date: Feb. 16, 2006

(54) Methods and system for detecting available parking places

(75) Inventors: Gaelle Jaupitre, Paris (FR); Cyril Hue, Ivry-Gargan (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/189,852

(22) Filed: Jul. 27, 2005

(30) Foreign Application Priority Data
Aug. 16, 2004 (EP) 04 292 055.3

(51) Int. Cl. G08G 1/14; G08B 13/00

(52) U.S. Cl. 340/932.2; 340/541

(57) ABSTRACT

By installing an emitter unit emitting signals in direction of a parking place and a responder unit corresponding to this parking place responding to the emitter signal by a response signal in case no car is parked on the respective parking place, and detecting the response signal or the lack of it, one can get information on the location of available parking places.

### BACKGROUND OF THE INVENTION

The invention is based on a priority application EP 04 292 055.3 which is hereby incorporated by reference.

The present invention relates to methods and a system for detecting available parking places.

As the number of cars has largely increased over the last decades, it has become quite difficult, especially in urban areas, to quickly find a parking place. Quite a number of parking places are provided e.g. in multi-storey car parks, but the only information on available parking space provided to the drivers of automobiles and other vehicles like motorbikes etc. is the number of free parking places in a car park. This number is provided e.g. by counting entering and exiting vehicles. Everyday experience has shown that these numbers are not very reliable. Furthermore, this information is not that helpful, because one still looses a lot of time, especially in very large car parks, actually finding an available parking place.

### SUMMARY OF THE INVENTION

It is an object of the present invention to allow for providing information on the location of available parking space.

This object, in addition to others, is achieved by means of methods according to claims 1, 2 and 3, and a system according to claim 6. Further advantageous features of this invention are indicated in the dependent claims. All the claims are understood to be integral parts of the description.

In a first aspect of the invention, there is provided a method for detecting available parking places, said method comprising the steps of emitting a signal in direction of a parking place, responding to the signal, if said parking place is available, and detecting, whether there is a response signal indicating an available parking place or not.

By monitoring a certain parking place, whether it is available or not with the help of a probing and a responding signal, the information on the location of the parking space is automatically available, too. In car parks or along a street—be it inside or outside—, every parking place can be monitored in this way, thus providing the location of one or more available parking places.

In a second aspect of the invention, there is provided a method for detecting available parking places, said method comprising the steps of installing an emitter unit emitting a signal, installing a responder unit corresponding to a parking place responding to the signal from the emitter unit in case the parking place is available, and installing a detector unit for detecting, whether the responder unit is responding to the signal emitted by the emitter unit.

Depending on the characteristics of the signal, in preferred embodiments of the invention, special units can be used that have the function of an emitter unit a well as of a detector unit.

In a third aspect of the invention, there is provided a method for detecting available parking places, said method comprising the steps of paving an area corresponding to a parking place with one or more responder units, installing an emitter unit emitting a signal that can be responded to by the responding unit, and detecting response or lack of response of said response unit, a lack of response from a certain responder unit indicating that this response unit is hidden by something located on the corresponding parking place.

In preferred embodiments of the present invention, three or more responder units are installed equidistantly in one or two directions wherein the equal distance between two responder units in one direction is less than the size of the smallest known vehicle in this direction, and the method further comprises the step of assessing the size of the available parking space as being the product of the number of neighbouring responder units responding to the emitter signal multiplied with said equal distance. This provides not only the location of parking spaces, but also the size of it, thus helping the driver to quickly find a parking space fitting the size of his or her vehicle. The length or the width as well as length and width of a parking space can thus be deduced.

In preferred embodiments, each responder unit responds to the signal from the emitter unit with a signal uniquely identifying the responder unit. This allows to easily find out, which parking place is free and which parking place is taken.

According to preferred embodiments of the present invention, the information on available parking space is provided to the drivers for example via local display, a radio network or a guidance system.

In a last aspect of the invention, there is provided a system for detecting available parking places comprising an emitter unit emitting a signal in direction of a parking place, a responder unit corresponding to said parking place, responding to the emitter signal, if the parking space is available, a detector unit detecting, whether the responder unit is responding to the emitter signal, and a processor unit processing the detected responder signals into information on available parking space.

According to preferred embodiments, the responder unit comprises specific forming means uniquely identifying the responder unit.

Preferably, the emitter unit and the responder unit are located such that the reflector unit will be hidden to the emitter unit, if a vehicle is located on the parking place, resulting in no response to the emitter signal.

In preferred embodiments of the present invention, emitter unit and responder unit as well as detector unit are chosen to work with wave signals, especially electromagnetic waves, such as visible light. This could lead to a light source as emitter unit, a reflector as responder unit, and eventually a camera as detector unit. Very preferred embodiments operate with radio frequency waves, preferably using a transceiver as emitter and detector unit and a transponder as responder unit.

According to preferred embodiments of the present invention, the system comprises a communication unit to provide the information on available parking space to the drivers for example via local display, a radio network or a guidance system.

The present invention has the advantage to locate a certain parking space by using a responder unit that is identifying the corresponding parking place. The actual number of emitter units, responder units and detector units depends on the size and the geometry of the parking area to be monitored. In car parks, parking lots or along the street, where more than one responder unit are monitored simultaneously by one or more detector units, the definite relation responder unit-parking place may for example be implemented as part of the responding signal being a unique identifier of the responder unit. Other possibilities can be the taking into account of the direction of the responding signal or the proceeding according to a definite time scheme of emitting a signal and detecting a response signal.

### BRIEF DESCRIPTION OF THE DRAWINGS

A detailed description of the invention is provided below. Said description is provided by way of a non-limiting example to be read with reference to the attached drawings in which:

FIG. 1 schematically shows the concept of the methods according to the present invention;

FIG. 2 schematically shows the concept of the system according to the present invention;

FIGS. 3a,b shows a first embodiment of the present invention;

FIGS. 4a,b shows a second embodiment of the present invention;

FIG. 5 shows a third embodiment of the present invention; and

FIG. 6 shows a further embodiment of the invention providing information on the location and size of available parking space.

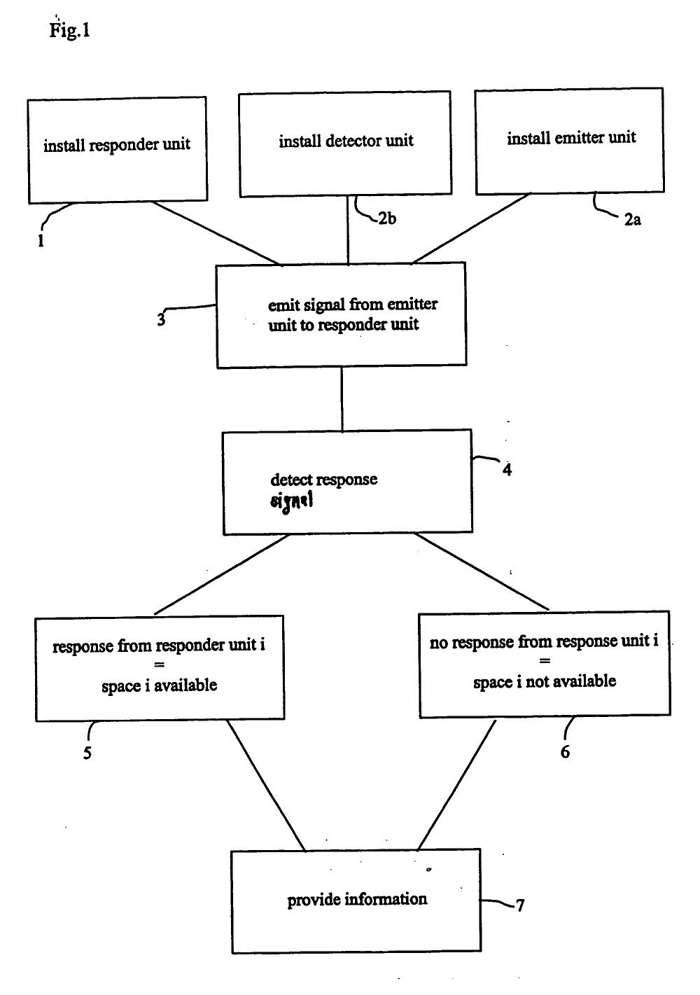

FIG. 1 schematically shows the concept of the methods according to the present invention. The core of the methods are the steps 3 to 6, i.e. the emitting of a signal from the emitter unit to the responder unit and the detecting whether the responder unit responded to the emitter signal, this being equivalent to the parking place corresponding to this specific responder unit being available, or not, this being equivalent to the parking place corresponding to this specific responder unit being not available.

One can use emitter units, responder units and/or detector units already present for other purposes or install units dedicated to the detecting of available parking space according to the invention (steps 1, 2a, 2b).

The information on the available parking space can be provided to the drivers in various ways (step 7). One possibility could be to have different local display, e.g. signposts or maps, throughout the neighbourhood or the parking lot or the multi-storey car park indicating in which direction to go to find available parking space. Preferably, the number and even the size of available parking places could be indicated. The information could as well be provided via radio signals such as radio signals that could be captured by the radio of the vehicle, by the car phone or by the cellular phone of the driver. Another possibility could be to feed the information into a guidance system. Guidance systems already exist on an individual level in vehicles, so-called navigation systems, or on the larger level of an urban agglomeration to guide the drivers to parking lots or car parks by signposts. It will be noted by the person skilled in the art that there are many more possibilities to make the parking space information available to drivers looking for parking space.

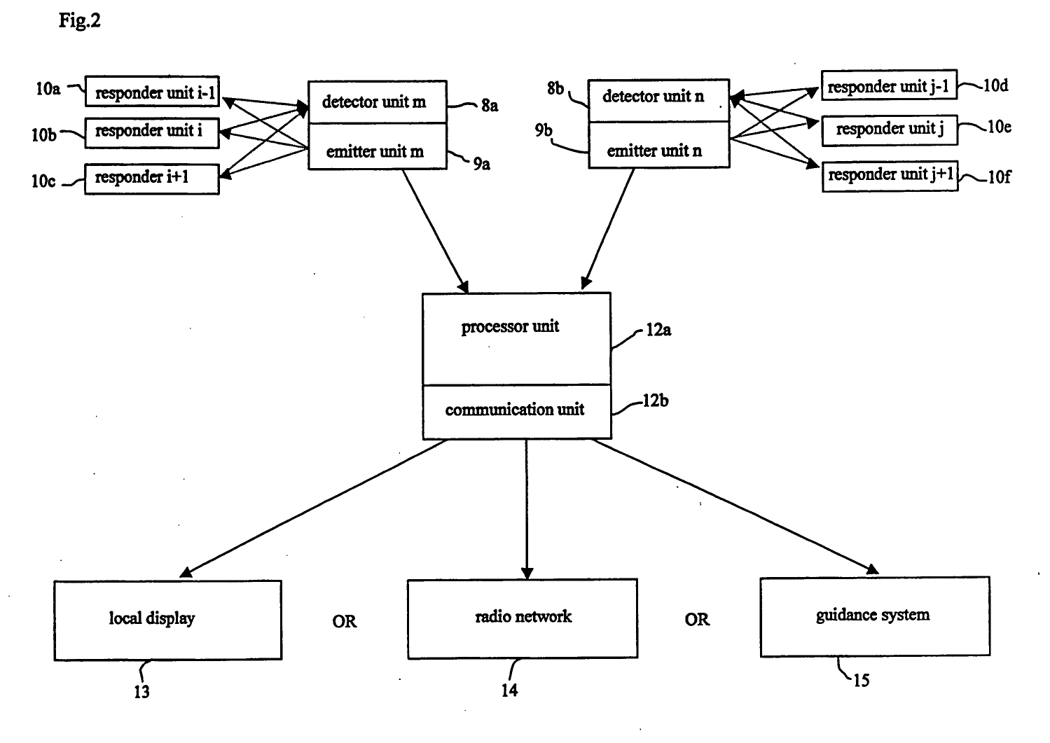

A system for providing information on available parking space according to the invention is sketched in FIG. 2 for the monitoring of a larger area. Several detector units and emitter units are provided, of which detector unit m 8a, detector unit n 8b, emitter unit m 9a and emitter unit n 9b are picked as examples for the present sketch. They each work together with several responder units, of which responder unit i−1 10a, responder unit i 10b and responder unit i+1 10c for detector unit m 8a and emitter unit m 9a as well as responder unit j−1 10d, responder unit j 10e and responder unit j+1 10f for detector unit n 8b and emitter unit n 9b are picked as examples. The responder units 10a-f, the emitter units 9a,b and the detector units 8a,b work together in that the emitter units 9a,b emit signals in direction of parking spaces to be monitored. Then, each responder unit 10a-f responds to the emitter signal in case the respective parking place corresponding to each responder unit 10a-f is available. If a responder unit does not respond to the emitter signal, the respective parking place is not available. The response signals are detected by the detector units 8a,b.

The actual number of emitter, responder and detector units depends on the size and the geometry of the area to be monitored. The number of emitter and detector units may be influenced by the capacity of these units in handling several signals simultaneously. But if choosing wave signals, in particular radio frequency waves, the capacity should not be a limitation.

In car parks, parking lots or along the street, where more than one responder unit are monitored simultaneously by one or more detector units, the definite relation responder unit-parking place may for example be implemented as part of the responding signal being a unique identifier of the responder unit. This is preferably done by including a specific signal forming means into the responder unit such that the responding signal is unique to the respective responder unit. Other possibilities can be the taking into account of the direction of the responding signal or the proceeding according to a definite time scheme of emitting a signal in direction of a certain parking place and detecting a response signal.

The information gathered by the detector units 8a,b is send to a processor unit 12a. For this purpose, the detector units 8a,b can be for example connected to cabled network, or a wireless network such as a mobile ad hoc network (MANET). The processor unit 12a processes the information to make it available to the drivers in search of a parking space. For example, the data can be transformed in a format to be passed on by a communication unit 12b to means for making the information available to the drivers, such as local display 13 or radio network 14 or to a guidance system 15 etc. The radio network 14 can be based on any known telecommunication technology such as GSM (global system for mobile communications), WLAN (wireless local area network), UMTS (universal mobile communications system) etc. A guidance system 15 can for example assist the driver to directly reach the nearest available parking place in the neighbourhood of his or her destination.

One of the important advantages of the system according to the invention is, that it can provide in real time the location of available parking space. This information can be provided to the drivers according to their actual location.

The processor unit 12a could be used as well for controlling the emitter units 9a,b and eventually the detector units 8a,b. This is particularly useful for sequential probing of the responder units 10a-f, i.e. emitting a signal to one responder unit after the other and detecting one response signal after the other to ensure the definite correlation of responder unit and respective parking place.

Depending on the design of the system according to the present invention, there could be provided a unit having both the functions of a processor unit 12a and a communication unit 12b.

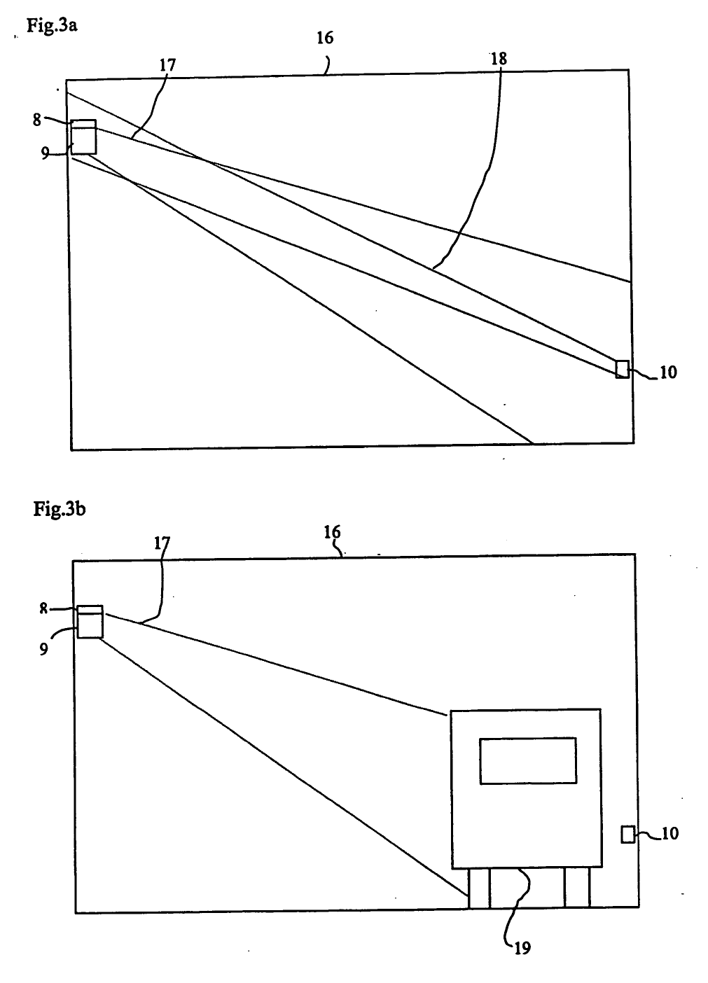

FIGS. 3a and 3b show a first embodiment of the present invention. Inside a multi-storey car park 16 a responder unit 10 is installed on one wall and a detector unit 8 and an emitter unit 9 are installed at an other wall such that the responder unit 10 is in the line of sight of the emitter unit 9 and the detector unit 8. When emitting an emitter signal 17 from the emitter unit 9 in direction of a parking space and the corresponding responder unit 10, the responder unit 10 will respond to it with a responding signal 18 in direction of the detector unit 8 in case the parking space is free (see FIG. 3a). If there is already a car 19 or another vehicle parking on this specific parking place, like in FIG. 3b, the responder unit 10 will not send any responding signal. In the present embodiment, this is, because the responder unit 10 is hidden behind the parked car 19. Thus the emitter signal 17 does not reach the responder unit 10 and the responder unit 10 has nothing to respond to.

Depending on the kind of signal chosen, e.g. ultrasonic signal, electromagnetic signal in the radio, visible, infrared etc. range, the responder unit 10 and the detector and emitter units 8,9 do not have to be in the immediate line of sight. For example, if visible light were used, one could use mirrors to transmit the emitter and the response signals 17, 18.

Applying the methods according to the invention in a multi-storey car park 16 is only one of many possibilities, as will be noted by the person skilled in the art. Other possible places could be an open parking lot or the side of a street where the responder units could be installed on house walls, the side walk, park meters or one could pave the parking space itself with responder units. The emitter and detector units 8,9 could be fixed on house walls, roofs, park meters, lampposts or traffic lights etc.

The embodiments having separate emitter units 9 and detector units 8 preferably work with visible light signals. In preferred embodiments of the present invention, emitter unit 9 is a light source, responder unit 10 is a reflector like e.g. a mirror, a prism or a white mark such as white traffic signalization on ground as already used. These reflectors reflect each a specific signal back to the detector unit. The detector unit can be any known optical detector and might be integrated into the emitter unit. The detector unit might be a camera, too. Each reflector can be identified by e.g. the amplitude, the spectrum or the direction of its response signal, or by the reflector's position. The signals can be formed e.g. by using special coatings filtering or polarising the reflected light or gratings to influence the response signal for uniquely identifying each reflector. In some embodiments of the invention, the detector unit 8 can be a webcam and the reflector a mark on the ground.

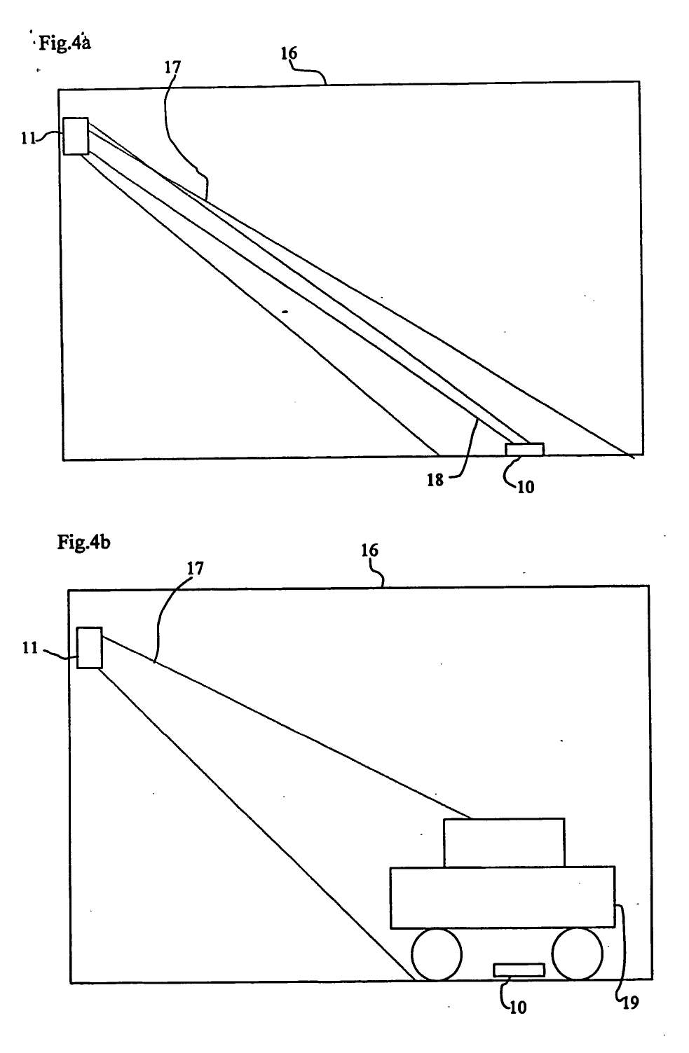

For the sake of simplicity of the drawings, the following examples will be dealing with embodiments, where the one unit 11 has the function of emitter unit as well as detector unit (see e.g. FIGS. 4a,b). In preferred embodiments of the present invention, radio frequency signals are employed such as used in the radio frequency identification technology (RFID). This allows to use a transceiver for emitting the probing radio signal 17 and detecting the response signal 18 as well as a transponder as responder unit 10.

In RFID technology, the transponder is also called tag and the transceiver reader. Each transponder or tag is sending a unique identifier back to the transceiver carrying the information, which parking place is corresponding to the specific transponder thanks to specific signal forming means like e.g. a filter influencing the amplitude and/or frequency of the response signal. Especially high frequency RFID components offer transmission ranges of up to ca. 30 m. Transmission power and sensitivity of the transceiver 11 or reader is chosen such that the transponder 10 or tag will not be able to transmit back to the transceiver 11 or reader the data it carries, i.e. the unique identifier, in case a car 19 or other vehicle is parked above it, in other words, when there is no line of sight propagation of the signals, as illustrated in FIG. 4b compared to FIG. 4b.

The RFID technology has the advantage to be very well developed. The components needed for implementing the present invention are readily available at very low costs. As tags, passive, semi-passive or active transponders may be used, depending on the availability of power supply and the needed transmission power for the response signal. For the power supply of the readers, for example, the power supply of a lamp can be used, if they are installed on lampposts.

The person skilled in the art will note, that it is possible as well to implement the present invention based on RFID technology using a radio antenna as emitter unit, the reader having the function of a detector unit.

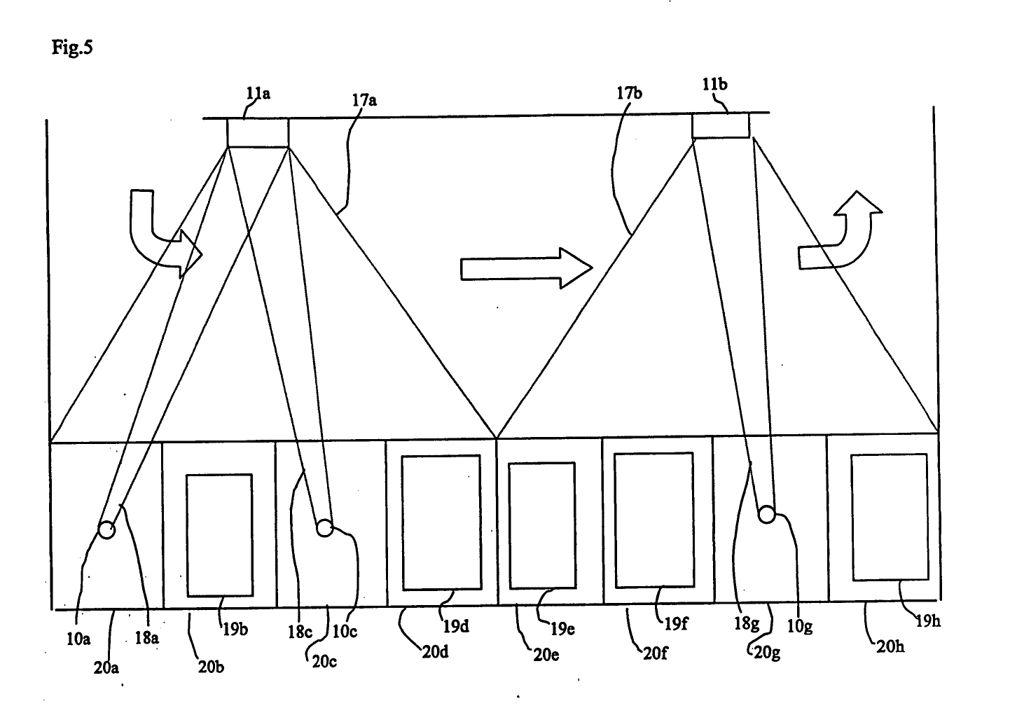

FIG. 5 shows a view of a level of a multi-storey car park with eight parking places 20a-h, where six cars 19b, 19d-f, 19h are parked. These eight parking places 20a-h are monitored with two transceivers 11a,b and transponders paved on the ground, of which only transponders 10a, 10c and 10g are visible, the others being hidden by the cars 19b, 19d-f, 19h. Transceiver 11a emits a probing signal 17a reaching the four parking spaces 20a-d on the left-hand side with the corresponding transponders; transceiver 11b emits a probing signal 17b reaching the four parking spaces 10e-h on the right-hand side with the corresponding transponders. Only the transponders 10a,c,g send back a response signal 18a,c,g to the transceivers 11a,b. The other transponders are hidden by the cars 19b, 19d-f, 19h and cannot respond to the emitter signals 17a,b, either because the transmission power of the transceivers 11a,b is too weak to reach the transponders through the cars 19b, 19d-f, 19h, and/or because the transmission power of the transponders is too weak to have the responding signals reach the transceivers 11a,b in spite of the cars 19b, 19d-f, 19h.

Each response signal 18a,c,g is carrying the unique identifier of the respective transponder 10a,c,g. This information identifying the available parking spaces 20a,c,g is received and processed by each transceiver to set up a list of the transponders not hidden by a car, i.e. transponders 10a,c for transceiver 11a and transponder 10g for transceiver 11b. This information is further processed by a processor unit, e.g. a server, not shown in FIG. 5, to readily provide the information on the location of the available parking places 20a,c,g to customers of the multi-storey car park.

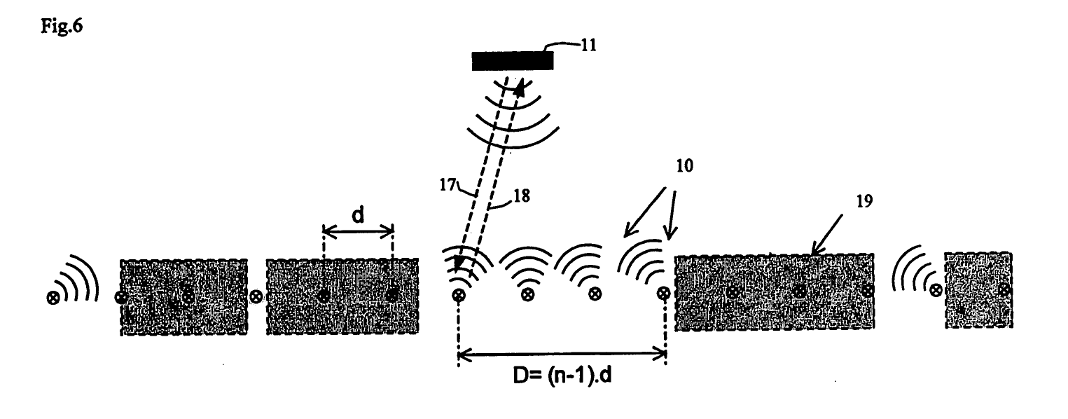

FIG. 6 schematically shows cars 19 parked one behind the other like parking along a side walk. The ground is equidistantly paved with transponders 10. The constant distance between to neighbouring transponders 10 is d. This distance d is set to be less than the length of the smallest known car. The transponders 10 are monitored by transceivers 11, one of which is shown in FIG. 6. In the preferred embodiment of the present invention illustrated in FIG. 6, the presence of an available parking place is indicated by three neighbouring transponders 10 emitting a response signal 18 in response to the emitter signal 17. The minimum number of neighbouring transponders 10 needed for a free parking space depends on the distance d. The actual number n of neighbouring transponders defining a free parking space is then used to asses an approximate length D of this parking place as being
D=(n−1)d.

This information on the size of the parking place is passed on to the drivers along with the location of the available parking place. If the information is provided to every driver individually, preferably only parking places large enough for the driver's vehicle are indicated to the driver.

The method of paving the ground or another area corresponding to parking place equidistantly with responding units works as well for gathering information on the width of the parking place or even both length and width, if the paving pattern is two-dimensional. The distances d₁, d₂ in both direction need not be equal.

It will be noted that the present invention can be implemented as well inside and outside and for most various parking spaces.

Although having described several preferred embodiments of the invention, those skilled in the art would appreciate that various changes, alterations, and substitutions can be made without departing from the spirit and concepts of the present invention. The invention is, therefore, claimed in any of its forms or modifications with the proper scope of the appended claims. For example various combinations of the features of the following dependent claims could be made with the features of the independent claim without departing from the scope of the present invention. Furthermore, any reference numerals in the claims shall not be construed as limiting scope.

1. A method for detecting available parking places, said method comprising the steps of:
emitting a signal in direction of a parking place;
responding to the signal, if said parking place is available;
detecting, whether there is a response signal indicating an available parking space or not.

2. A method for detecting available parking places, said method comprising the steps of:
installing an emitter unit emitting a signal;
installing a responder unit corresponding to a parking place responding to the signal from the emitter unit in case the parking place is available;
installing a detector unit for detecting, whether the responder unit is responding to the signal emitted by the emitter unit.

3. A method for detecting available parking places, said method comprising the steps of:
paving an area corresponding to a parking place with one or more responder units;
installing an emitter unit emitting a signal that can be responded to by the responding unit;
detecting response or lack of response of said response unit, a lack of response from a certain responder unit indicating that this response unit is hidden by something located on the corresponding parking place.

4. The method according to claim 2, wherein three or more responder units are installed equidistantly in one or two directions and wherein the equal distance between two responder units in one direction is less than the size of the smallest known vehicle in this direction, and comprising the further step of assessing the size of the available parking place as being the product of the number of neighbouring responder units responding to the emitter signal multiplied with said equal distance.

5. The method according to claim 2, wherein each responder unit responds to the signal from the emitter unit with a signal uniquely identifying the responder unit.

6. The method according to claim 1 further comprising the step of providing the information on available parking places by local display, a radio network or a guidance system.

7. A system for detecting available parking places comprising
an emitter unit emitting a signal in direction of a parking place;
a responder unit corresponding to said parking place, responding to the emitter signal, if the parking place is available;
a detector unit detecting, whether the responder unit is responding to the emitter signal;
a processor unit processing the detected responder signals into information on available parking places.

8. The system according to claim 7, wherein the responder unit comprises specific signal forming means uniquely identifying the responder unit.

9. The system according to claim 7, wherein the emitter unit and the responder unit are located such that the reflector unit will be hidden to the emitter unit, if a vehicle is located on the parking place, resulting in no response to the emitter signal.

10. The system according to claim 7 comprising a transceiver as emitter and detector unit and a transponder as responder unit.

11. The system according to claim 7 comprising a light source as emitter unit and a reflector as responder unit.

12. The system according to claim 7 comprising a communication unit providing the information on available parking space to a local display, a radio network or a guidance system.

13. The method according to claim 3, wherein three or more responder units are installed equidistantly in one or two directions and wherein the equal distance between two responder units in one direction is less than the size of the smallest known vehicle in this direction, and comprising the further step of assessing the size of the available parking place as being the product of the number of neighbouring responder units responding to the emitter signal multiplied with said equal distance.

14. The method according to claim 3, wherein each responder unit responds to the signal from the emitter unit with a signal uniquely identifying the responder unit.
